(19) United States
(12) Patent Application Publication
(10) Pub. No.: US 2024/0255318 A1
(43) Pub. Date: Aug. 1, 2024

(54) NON-CONTACT ENCODER FOR BOARD MEASUREMENT

(71) Applicant: United States Gypsum Company, Chicago, IL (US)

(72) Inventor: Leslie Eversole, Milton, PA (US)

(21) Appl. No.: 18/242,129

(22) Filed: Sep. 5, 2023

Related U.S. Application Data
(60) Provisional application No. 63/441,238, filed on Jan. 26, 2023.

(51) Int. Cl. G01D 5/26; B65G 43/08; F26B 25/00

(52) U.S. Cl. CPC G01D 5/266; B65G 43/08; F26B 25/004; B65G 2203/0208; B65G 2203/044

(57) ABSTRACT

A system and methods using the system for processing a wallboard panel, the system comprising: a post-kiln conveyor having a surface configured for receiving a post-kiln wallboard panel and moving horizontally the post-kiln wallboard panel on the conveyor surface with one of the two long surfaces contacting the conveyor surface; and a non-contact encoder configured for producing a laser beam, splitting the laser beam into at least a first laser beam and a second laser beam, and transmitting the first laser beam and the second laser beam to the conveyor surface, the non-contact encoder being mounted vertically above the post-kiln conveyor at a distance from the conveyor surface, the distance configured such that the first laser beam and the second laser beam intersect fully or substantially fully at a long surface of the post-kiln wallboard panel when the post-kiln wallboard panel is passing under the non-contact encoder.

### CROSS-REFERENCE TO RELATED APPLICATIONS

This application claims the benefit of priority from U.S. Provisional Patent Application 63/441,238 filed Jan. 26, 2023, the entire disclosure of which is herein incorporated by reference.

### TECHNICAL FIELD

This disclosure relates to systems and methods for continuous wallboard manufacturing and in particular to quality-control systems and quality-control methods useful in continuous wallboard manufacturing.

### BACKGROUND

Wallboards are commonly used in construction, including for building interior walls and ceilings. A wallboard may be manufactured by mixing a gypsum slurry and distributing the gypsum slurry between two paper cover sheets for example, as described in U.S. Pat. No. 9,745,222, the entire disclosure of which is herein incorporated by reference.

During production on a wallboard production line, a continuous ribbon of wallboard precursor is made by depositing onto a conveyer belt a first sheet of facer material, distributing a gypsum slurry onto the facer and covering the distributed gypsum slurry with a second sheet of facer material, the backer. This sandwiched continuous ribbon of wallboard precursor may be moving on the conveyer belt until gypsum is set sufficiently for the ribbon to be cut into individual wallboards which are then transferred into a drying oven (kiln). Various methods are known in the art for monitoring and measuring the width of the gypsum wallboard and edge profiles while a ribbon precursor is moving on the conveyor. For example, U.S. Pat. No. 9,745,222 describes a method in which at least one laser scanner and processor are installed at the wallboard production line, monitoring the width and edge profiles of a gypsum wallboard in real time during manufacturing. PCT publication WO 2000/012963 describes a method and system for detecting the edge angle of a gypsum board. The system comprises a light source and camera and requires pictures to be taken for obtaining information about slurry distribution in a gypsum board.

After wallboard panels are dried in a kiln, they are transferred for post-kiln quality inspection which determines whether a finished wallboard panel complies with specification requirements and is ready to be packaged and shipped to consumers.

Currently, there is a need in the field for non-contact systems and methods that can quickly and accurately process post-kiln wallboard panels moving on a conveyor for compliance with specification requirements.

### SUMMARY

This disclosure provides a manufacturing system equipped with a non-contact encoder and methods in which the system processes wallboard panels moving on a conveyor for compliance with specification requirements, including verification of wallboard length, width, thickness and/or an edge profile. With these systems, multiple wallboard panel dimensions may be verified expeditiously by using a split laser beam. Therefore, a time necessary for specification compliance verification may be reduced, improving production efficiency and resulting in labor and energy savings.

In one aspect, this disclosure provides systems and methods in which it is not necessary for an encoder to be brought in physical contact with a wallboard panel and roller mechanisms, and therefore, slippage and wallboard panel damage typical with mechanical encoders that contact the board can be avoided or minimized.

This disclosure provides a system for processing a post-kiln wallboard panel having a length, a width and a thickness, the length being longer than the width, the post-kiln wallboard panel having two long surfaces, a front long surface and a back long surface, the post-kiln wallboard panel having a first long edge and a second long edge. The system may comprise:
a post-kiln conveyor having a surface configured for receiving a post-kiln wallboard panel at a first location,
the conveyor surface further configured for moving horizontally the post-kiln wallboard panel on the conveyor surface from the first location to a second location,
the conveyor surface being sized for moving the post-kiln wallboard panel with one of the two long surfaces contacting the conveyor surface and the other long surface not contacting the conveyor surface; and
a non-contact encoder configured for producing a laser beam, splitting the laser beam into at least a first laser beam and a second laser beam, and transmitting the first laser beam and the second laser beam to the conveyor surface,
the non-contact encoder being mounted vertically above the post-kiln conveyor at a distance from the conveyor surface, the distance configured such that the first laser beam and the second laser beam intersect and overlap fully or substantially fully at the non-contacting long surface of the post-kiln wallboard panel when the post-kiln wallboard panel is passing under the non-contact encoder.

In embodiments, the non-contact encoder may be configured for splitting the laser beam into 2, 3, or 4 laser beams. In some embodiments, the distance may be in the range from about 8 inches to about 12 inches from the conveyor surface. Preferably, the non-contact encoder is mounted perpendicular or substantially perpendicular to the direction of wallboard panel movement. Preferably, the surface of the post-kiln conveyor may be sized for moving the post-kiln wallboard panel with the wallboard long edges being moved in the machine direction. Preferably, the first laser beam and the second laser beam intersect at 60 degrees or less than 60 degrees.

In some embodiments, the conveyor surface may have a first portion, a second portion separated from the first portion by a gap, wherein the gap is perpendicular to a direction of the movement from the first location to the second location, and wherein the gap has a width which is smaller than the length or the width of the post-kiln wallboard panel, and wherein the gap is configured for the post-kiln wallboard panel to traverse the gap from the first portion to the second portion of the conveyor surface, and wherein the non-contact encoder transmits the first laser beam and the second laser beam to the gap area. Preferably, the first portion of the conveyor surface may comprise one or more rollers or a belt and the second portion of the conveyor surface may comprise one or more rollers or a belt.

In some embodiments, the post-kiln conveyor surface may have a bend and/or rotating table at which a movement direction of wallboard panel long edges may be changed from the machine direction to the cross-machine direction or vice versa. A second non-contact encoder may be positioned after the bend, but before the second location.

In embodiments, a non-contact encoder suitable in the systems according to this disclosure may comprise:
a) a laser source configured for emitting a laser beam;
b) a laser beam splitter configured for spilling the emitted laser beam into at least a first laser beam and a second laser beam and directing the second beam to intersect with the first laser beam at the distance;
c) a sensor detecting laser light reflected from the non-contacting long surface, and
d) a processor.

The system may further include one or more of the following stations and/or components: a production line; a kiln; one or more controllers; a packaging station, the packaging station located at or after the second location; and/or a non-compliant product ramp positioned after the non-contact encoder, the non-compliant product ramp being configured for receiving the wallboard panel from the post-kiln conveyor. Preferably, the non-compliant product ramp may be separated from the post-kiln conveyor by a gate, the gate having an open position and a closed position, the non-compliant product ramp configured for receiving the wallboard panel from the post-kiln conveyor when the gate is in the open position and the gate blocking the non-compliant product ramp from receiving the wallboard panel when the gate is in the closed position.

In another aspect, this disclosure relates to a method for processing a post-kiln wallboard panel. The method may comprise:
1) Positioning the post-kiln wallboard panel on the moving conveyor surface of the system of claim 1 at the first location such that a long surface of the post-kiln wallboard panel is in contact with the post-kiln conveyor surface,
2) Illuminating a non-contacting long surface of the moving post-kiln wallboard panel with the first laser beam generated by the non-contact encoder and the second laser beam generated by the non-contact encoder, wherein the first laser beam and the second laser beam intersect at the non-contacting long surface,
3) Capturing laser light reflected from the non-contacting long surface,
4) Processing captured laser light of step 3) into velocity data,
5) Calculating a value for at least one dimension of the post-kiln wallboard panel by using the velocity data obtained in step 4),
6) Analyzing the dimension value calculated in step 5) against a tolerance range and encoding the post-kiln wallboard panel as a compliant product or non-compliant product, and
7) Transferring the post-kiln wallboard panel from the post-kiln conveyor to a packaging station if the post-kiln wallboard panel is encoded as the compliant product, or transferring the post-kiln wallboard panel to a non-compliant product ramp if the post-kiln wallboard is encoded as the non-compliant product.

With the method, one of the following dimensions may be calculated in step 5): a length, a width and/or a thickness of the post-kiln wallboard panel. Preferably, the method may further comprise plotting a long edge profile and displaying it on a display. In some embodiments, the method may further comprise taping edges of the post-kiln wallboard panel at the packaging station. Preferably, the method may further comprise transferring a non-compliant post-kiln wallboard panel from the non-compliant ramp to recycling.

In preferred embodiments, a length may be calculated in step 5) and the tolerance range is defined as no more than 5 mm negative deviation from a specification value for the length and/or wherein a width may be calculated in step 5) and the tolerance range is defined as no more than 3 mm negative deviation from a specification value for the width.

In yet another aspect, this disclosure relates to a method for manufacturing a wallboard panel. The method may comprise:
mixing a gypsum slurry from calcined gypsum, water and one or more additives;
depositing the gypsum slurry on a facer paper cover sheet continuously moving on a production line;
covering the gypsum slurry with a backer paper cover sheet;
forming a ribbon precursor of wallboard panel;
cutting the ribbon into wallboard panels;
transferring the wallboard panels to a kiln;
drying the wallboard panels in the kiln;
transferring the wallboard panels from the kiln; and
performing at least steps 1) through 7) of the method for processing the post-kiln wallboard panel.

### BRIEF DESCRIPTION OF THE DRAWINGS

FIG. 1 is a perspective view of a wallboard with tapered machine-direction edges. This illustration is not drawn to scale.

FIG. 2 is a fragmentary schematic side view of a system comprising one embodiment of a non-contact encoder for processing post-kiln wallboards continuously moving on a conveyor. This illustration is not drawn to scale.

FIG. 3 is a fragmentary schematic perspective view of one embodiment of the system according to this disclosure, showing a position of the non-contact encoder relevant to the conveyor and a wallboard panel to be measured. This illustration is not drawn to scale.

FIG. 4 is a flowchart illustrating one embodiment of a method which comprises processing a moving post-kiln wallboard panel with a non-contact encoder.

### DETAILED DESCRIPTION

In this disclosure, the term “calcined gypsum” may be used interchangeably with any of the following terms: calcium sulfate hemihydrate, stucco, calcium sulfate semi-hydrate, calcium sulfate half-hydrate or plaster of Paris.

In this disclosure, the term “gypsum” may refer to any of the following: naturally mined gypsum (ore), landplaster and/or synthetic gypsum. The term “gypsum” may be used interchangeably with the term “calcium sulfate dihydrate.” The “synthetic gypsum” can be also referred to as “chemical gypsum.”

In this disclosure, the term “wallboard” means a gypsum panel having a gypsum matrix core sandwiched between two cover sheets. The term “wallboard” may be used interchangeable with any of the following terms: gypsum panel, gypsum wallboard, drywall, gypsum board or board. The cover sheets may be paper, glass mat or other materials known in the art.

In this disclosure, the term “about” means a range of plus/minus 5% of the stated value. For example, “about 100” means 100±5 and “about 200” means 200±10.

In this disclosure, the term “wt %” means percentage by weight.

When stucco (CaSO₄·1/2H₂O) is mixed with water into a slurry, stucco hydrates and sets into a gypsum matrix. This setting reaction can be described by the following equation:

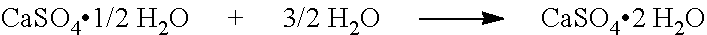

In this disclosure, “calcination” means a process by which gypsum (CaSO₄·2H₂O) is dehydrated into calcined gypsum (CaSO₄·1/2H₂O). The process includes heating gypsum to evaporate crystalline water. Calcined gypsum can be produced in different crystalline forms such as alpha calcium sulfate hemihydrate and beta calcium sulfate hemihydrate. All crystalline forms and any mixtures thereof are suitable for compositions according to this disclosure.

In this disclosure, various tests may be described. If no temperature, atmospheric pressure and/or humidity is mentioned in connection with a particular test, it means that the test was conducted at room temperature defined as 68 to 77° F. (20 to 25° C.), normal atmospheric pressure of about 101 kPa and a humidity in the range from about 68 to about 75 percent.

In this disclosure, ASTM tests refer to tests published by ASTM International, formally known as American Society for Testing and Materials. Detailed test protocols for ASTM tests are available from the ASTM International website.

In this disclosure, “a gypsum slurry” means a water-based gypsum slurry in which calcined gypsum is mixed with at least water, and preferably further with one or more additives.

This disclosure provides non-contact systems and methods for quality-control processing of post-kiln wallboard panels. Wallboard panels with different type of machine-direction edges are known in the field, including square or tapered edges. Systems and methods according to this disclosure are suitable for any wallboards, and in particular, the systems and methods provide a technical improvement for measuring more accurately the width, thickness and edge profiles for wallboards with tapered edges.

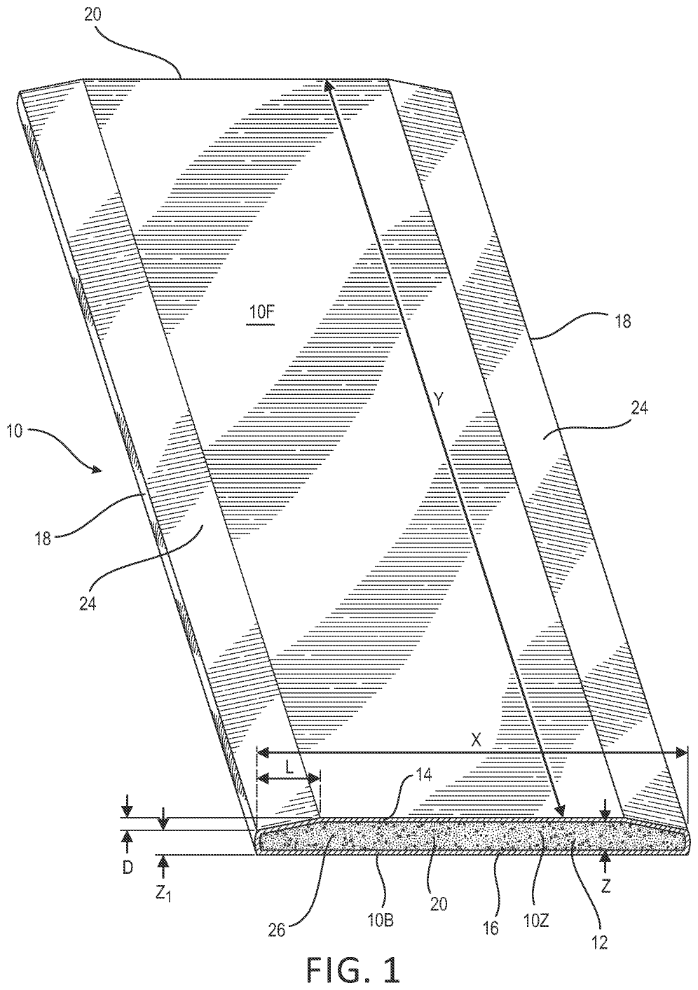

Referring to FIG. 1, one embodiment of a wallboard with taped edges, generally (10) is shown. The wallboard (10) is composed of a set gypsum core (12) sandwiched between and adhered to two paper cover sheets, a face paper cover sheet which can be also referred to as a facer (14), and a back paper cover sheet which can be also referred to as a backer (16). In some embodiments, the gypsum core (12) is adhered to the paper cover sheets (14 and 16) directly. In other embodiments, at least one of the cover sheets (14 and 16) may contain an adhesive coating over at least a portion of the surface which is in contact with the gypsum core (12). In some embodiments, the gypsum core (12) may contain one or more layers, each layer formulated from a first gypsum slurry that may differ from one or more gypsum slurries used in other layers, or the first gypsum slurry may be substantially the same as the one or more gypsum slurries. In some preferred embodiments, the gypsum core (12) may have a density of from about 30 pcf to 40 pcf. If a gypsum core (12) contains several layers, the layer in contact with the facer cover sheet (14) and/or the backer cover sheet (16) may have a density greater than a density of a central core layer.

Paper cover sheets (14 and 16) may comprise Manila paper, kraft paper and/or newsline paper. A multi-ply paper can be used, e.g., Manila heavy paper and MH Manila HT (high tensile) paper. A face paper cover sheet (14) and aback paper cover sheet (16) may be made from different paper grades and each of the cover sheets may be of different weight. Suitable paper weight ranges may include, but are not limited to, the range from about 33 lbs/MSF to about 65 lbs/MSF. For example, a face cover sheet (14) may comprise manila paper of high density, preferably about 55 to about 65 lb/msf, but a paper cover sheet of different weight can be used as well. Newsline paper of lower density of about 35 to about 45 lbs/mfs can be used as back cover sheet (16). In some embodiments, one or both cover sheets (14 and 16) may have a coating, such as for example, as mold-resistant and/or water-resistant, on the cover sheet surface which is not attached to the gypsum core (12).

The gypsum core (12) contains a set gypsum which preferably intermixed with various additives. Suitable additives may include, but are not limited to, one or more of the following: starch, fibers, a dispersant, a foaming agent, a phosphate compound and/or agents that accelerate or delay a setting reaction in a gypsum slurry.

The gypsum core (12) can be formed from a gypsum slurry in which calcined gypsum (stucco) hardens (sets) by reacting with water. Suitable calcined gypsum (stucco) can be obtained by calcining naturally occurring gypsum and/or synthetic gypsum. Suitable gypsum slurries include those in which a water-to-calcined gypsum ratio by weight (known as the water-to-stucco ratio, WSR) is in the range from 0.5 to 1.5, preferably from 0.5 to 1.3, more preferably from 0.7 to 1, and most preferably from 0.7 to 1.3, e.g., 0.7, 0.8, 0.9, 1, 1.1, 1.2 or 1.3. A gypsum slurry may comprise from about 40 wt % to about 70 wt % of calcined gypsum. Gypsum slurries may comprise various additives.

When walls or ceilings are assembled from the wallboards (10), each wallboard is typically attached to a stud, e.g., a wood stud, such that the back cover sheet (16) is facing toward the stud, while the face cover sheet (14) is on the opposite side. When the wallboard (10) is attached to a stud, the face cover sheet (14) is facing a room.

As described in U.S. Pat. No. 8,931,230, the entire disclosure of which is herein incorporated by reference, wallboard edges are generally identified as being in the machine direction or cross-machine direction, based on the wallboard orientation during its formation on a manufacturing conveyor which is continuously moving. Edges along the direction in which the conveyor (machine) is moving are normally the longer edges than the cross-machine edges. The machine-direction edges are usually wrapped with a paper cover sheet during wallboard manufacture in which a gypsum slurry is deposited on a moving paper cover sheet (e.g., on a conveyor) to initially form a long, continuous ribbon of wallboard precursor which is eventually cut into wallboards in the cross-machine direction. The wallboards are then transferred into a kiln for drying.

A wallboard panel (10) has two machine-direction edges (18 and 18) as shown in FIG. 1. The wallboard panel (10) also has two cross-machine edges (20 and 20). In this disclosure, the machine-direction edges (18 and 18) may be referred to as “long edges.” The machine-direction edges are in lateral spaced relationship to each other along a cross-machine direction. In this disclosure, the cross-machine edges (20 and 20) may be referred to as “short edges.”

The wallboard panel (10) has the following dimensions: a width (X), a length (Y) and a thickness (Z) as shown in FIG. 1. Wallboards may have thickness (Z) from about 14 inch to about one inch, depending on their expected use and application. Wallboards may include those with a length (Y) in the range of 8 to 16 ft., e.g., 8 ft, 10 ft or 16 ft (2438-4877 mm), a width (X) of 4 ft. (1219 mm) or 54 in. (1372 mm). Any of these panels can have a thickness from about ¼ inch to about one inch, with some preferred embodiments having a thickness (Z) of ⅝ inch (15.9 mm). In embodiments, wherein the wallboard has tapered edges, its thickness (Z₁) in the tapered portion may be reduced from thickness (Z) in the central portion of the wallboard. In some preferred embodiments, (Z₁) may be reduced from (Z) by about a value in the range from about 0.001 inch to about 0.08 inch.

Preferably, a value of length (Y) is greater than a value of width (X) and accordingly, the wallboard panel (10) has two long surfaces: a first (front) long surface (10F) which is covered with the face paper cover sheet (14) and is facing the room after installation and a second (back) long surface (10B) which is opposite to the first front long surface (10F). The back long surface (10B) is covered with the back paper cover sheet (16) and is facing toward a stud after the wallboard (10) has been attached to the stud. The wallboard panel (10) also has two cross-machine surfaces, a first of which (10z) is shown in FIG. 1, and its opposite second cross-machine surface which is not visible in the drawing of FIG. 1. In this disclosure, the front long surface (10F) may be referred to as “the front surface.” In this disclosure, the back long surface (10B) may be referred to as “the back surface.”

In the embodiment of FIG. 1, both machine-direction edges (18 and 18) are tapered, meaning that the wallboard (10) tapers on its front long surface (10F) from the wallboard thickness (Z) to a reduced thickness (Z₁), wherein (Z₁)<(Z), toward each of the two machine-direction edges (18), while the back long surface (10B) may remain flat and does not taper. Thus, the front long surface (10F) has a recess (taper) (24) at each of the two machine-direction edges (18). A depth (D) of the recess (24) may vary. In some embodiments, the depth (D) of the recess (54) may be in the range from about 0.001 inch to about 0.08 inch, when measured at the lowest point of the taper slope. The length of the recess (taper) (24) (L) may vary, including some embodiments, wherein the length (L) may be in the range from about ¼ inch to about ⅔ inch. The depth (D) and the length (L) are two important measurements in defining an edge profile (shape, contour or outline) of the machine-direction edge (18).

After a wallboard panel is dried in a kiln, but before this post-kiln wallboard panel can be packaged and shipped to a user, it must be processed for compliance with product specifications, including the width (X), the length (Y) and edge profiles, among other specification requirements.

In one aspect, this disclosure provides a system for post-kiln processing of wallboard panels as well as for continuous manufacturing of wallboard panels, including wallboards such as wallboard panel (10), but any other wallboard panels or tiles can be also processed/manufactured by using the system. The system comprises a non-contact encoder for quality-control processing of post-kiln wallboard panels.

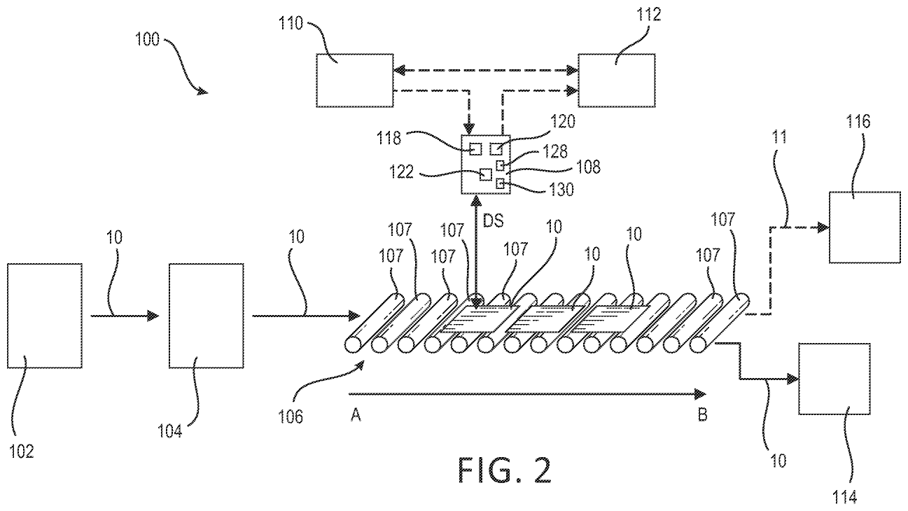

Referring to FIG. 2, one embodiment of the system, generally (100), is shown. The system (100) includes a post-kiln conveyor having a surface (106) for transporting wallboard panels, a non-contact encoder (108), a processor (112), a packaging station (114), a non-compliant product ramp (116), and preferably at least one controller (110). The system (100) may further include a production line (102) and a kiln (104).

The system (100) includes a post-kiln conveyor (106) configured for receiving, e.g., from the kiln (104), and moving horizontally the post-kiln wallboard panels (10s) from a first location (A) to a second location (B). In order to move wallboard panels, the post-kiln conveyor (106) may be equipped with a motor rotating the conveyor surface which may be a belt surface or a plurality of rollers, one embodiment of which (107s) is shown in FIG. 2, but any other surface, e.g. a platform, a pan, foldable steps, etc. sized for moving a wallboard panel from a first location to a second location may be also used.

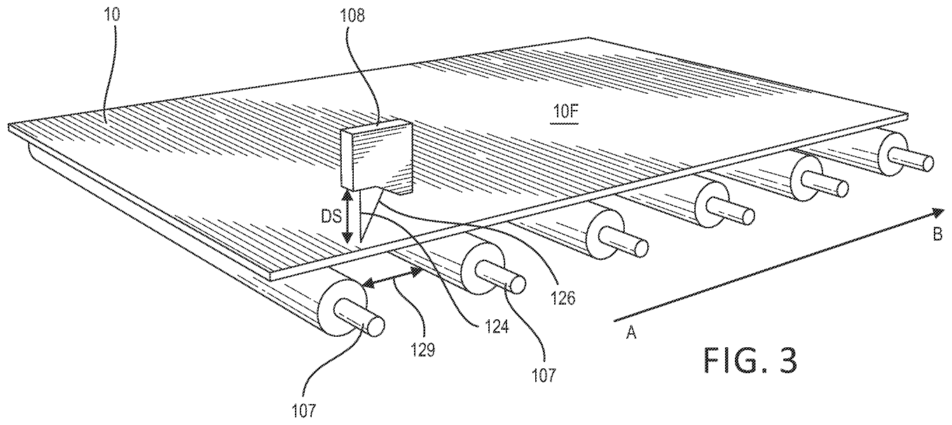

When being moved on the post-kiln conveyor (106), one of the two long surfaces, front (10F) or back (10B) of the wallboard panel (10) is contacting the conveyor surface. This long surface may be referred hereafter as the contacting long surface. A long surface opposite to the contacting surface is above the conveyor (106) and is not in contact with the conveyor surface. This opposite long surface may be referred to as the non-contacting long surface. In the embodiment shown in FIG. 3, the non-contacting surface is (10F) is the face long surface of the wallboard panel (10). In other embodiments, the non-contacting surface may be (10B).

The wallboard panel (10) may be moved on the conveyor (106) with the long edges (18) moving in the machine direction A to B, or the wallboard panel (10) may be moved on the conveyor (106) with short edges (20) moving in the machine direction A to B. Preferably, the wallboard panel (10) is moved with long edges (18) in the machine direction A to B.

In some embodiments, the post-kiln conveyor surface may include a bend and/or rotating table, e.g., a 90-degree bend (not shown), wherein a direction of movement for wallboard panel long edges (18) may be changed from the machine direction to the cross-machine direction or vice versa. In these embodiments, a second non-contact encoder (not shown) may be installed after the bend and/or rotating table such that while a first non-contact encoder installed before the bend and/or rotating table determines a length of the moving wallboard panel, the second non-contact encoder determines a width of the moving wallboard panel, or vice versa.

In some embodiments, the surface of the conveyor (106) may have a first portion and a second portion, the second portion being separated from the first portion by a gap or space (129). For example, when the surface of the conveyor (106) is formed by a plurality of rollers, the gap (129) may be a gap between two adjacent rollers (107s). In other embodiments, the first portion and/or the second portion may be formed by two belts or platforms separated by the gap (129). Preferably, a width of the gap (129) is significantly smaller than a width and a length of a wallboard panel such that the wallboard panel can traverse from the first portion to the second portion of the post-kiln conveyor (106).

The system (100) includes a non-contact encoder (108) mounted vertically or substantially vertically above the post-kiln conveyor (106) at a distance (DS) from the surface (10F) of the wallboard panel (10) when the wallboard panel (10) is passing under the non-contact encoder (108) on the post-kiln conveyor (106). Preferably, the distance (DS) may be in the range from about 8 inches to about 12 inches from the surface (10F). Preferably, the non-contact encoder is mounted perpendicular (at a 90-degree angle) or substantially perpendicular (90 degree plus/minus 2 degrees) to the direction of movement (A to B).

Preferably, the non-contact encoder (108) may be a laser interferometer which may comprise: a) at least one laser source (118) configured to emit a laser beam; b) a laser beam splitter (120) configured to split the emitted laser beam into several laser beams, e.g. 2, 3, or 4, and preferably, into a first laser beam (124) and a second laser beam (126); c) one or more sensors (122) configured to detect laser light reflected from the non-contacting long surface (10F or 10B); d) a processor (128); and one or more user displays (130).

The laser source (118) may contain a laser diode configured to generate a laser beam while using electricity. Preferably, the laser beam may be collimated and monochromatic. Coherent laser beams are preferred, but a pulsing laser beam may be also used in some embodiments. Suitable laser beams include near-infra red laser beams. In some embodiments, the laser source (118) may be configured to generate two or three laser beams, preferably, each laser beam being generated at a different wavelength.

The splitter (122) may comprise one or more optic lenses and mirrors configured to split the laser beam generated by the laser beam source (118) into two or more split laser beams, preferably at least two laser beams, a first laser beam (122) and a second laser beam (124). The splitter may contain one or more reflecting mirrors which cause split laser beams, preferably the first laser beam (124) and the second laser beam (126) to intersect at a distance (DS).

When the first laser beam (124) and the second laser beam (126) intersect, the two beams interfere and generate a set of fringes. In some embodiments, the splitter (122) may be configured to split the initial laser beam in more than two laser beams, e.g., 3, 4 or 5 laser beams. Using more than 2 laser beams may permit measuring two length values at the same time and also measuring a corresponding angle. Using the non-contact encoder (108), a wallboard surface profile can be generated. This may be particularly helpful for wallboard panels with tapered edges, wherein it may be important to verify that dimensions, including L and/or D, for each tapper (24) are withing the requirement specifications.

The first laser beam (124) and the second laser beam (126) intersect at an angle, preferably at a 60-degree angle or less than a 60-degree angle. In some embodiments, the first split beam (124) and the second split beam (126) may intersect at an angle in the range from 5 to 60 degrees, and preferably, at the range from 5 to 40 degrees, and more preferably from 10 degrees to 30 degrees. Suitable beam splitters are known in the art, including as disclosed in U.S. Patent Publication 2021/0088320, the entire disclosure of which is herein incorporated by reference.

When the wallboard panel (10) is moving on the conveyor (106) and is passing through the set of fringes generated by the interfering laser beams, for example the interfering laser beams (124 and 126), the non-contacting long surface (10F or 10B) reflects laser light.

This reflected laser light may be collected and converted into electrical signals by the sensor (122) which is operably connected to the processor (128). When in use, the sensor (122) may transmit electrical signals to the processor (128) which may be configured for processing the received electrical signals into frequency data points which are directly proportional to the velocity of the moving wallboard panel (10). Velocity data points may be integrated by using the Doppler effect equation which can used for computing a length or a width of the wallboard panel (10), depending on whether the wallboard panel is moving in the machine direction lengthwise or widthwise. In some embodiments, the following equations can be used in order to calculate the length of the moving wallboard panel (10).

$$d = \frac{λ}{2 sin κ}$$

Wherein, (d) is a fringe distance, (k) is a laser wavelength, (sin) is a sinus, and (κ) is a laser beam angle.
Time (t) is the inverse of electric signal frequency (f):

$$t = \frac{1}{f}$$

Velocity (ν) is the distance (d) divided by the time t).

$$v = \frac{d}{t}$$

The length of wallboard panel (L) can be calculated by integrating velocity (v)

$$L = {\int }_{0}^{T} v \cdot dt$$

Wherein 0 to T is a time period during which the wallboard panel is passing under the non-contact encoder.

The non-contact encoder (108) may be further configured to produce an output by plotting a long surface profile, including edge profiles of the wallboard panel (10) on the display (130), which may be particularly helpful in manufacturing wallboards with tapered edges.

The non-contact encoder (108) may further comprise one or more user displays (130), preferably at least one of them being a touch-screen display, which may serve as a user interface and/or input/output devices, such as for example, including keyboard and/or a display screen, which may be adapted to receive input signals from a user and also to provide output signals for a user, including a graphic interface displaying to a user the long surface profile, including edge profiles.

In preferred embodiments, the non-contact encoder (108) is positioned vertically or substantially vertically above the conveyor surface (106) at the distance (DS) which is adjusted such that the interfering beams, at least the first beam (124) and the second beam (126) intersect and fully or substantially fully overlap, e.g., at least a 95%, 90% or 80% overlap of beam areas, at the wallboard non-contacting long surface when the wallboard panel is passing under the non-contact encoder. This overlapping area between the two beams is a measuring area, which can be also referred to as the depth of field, from which the reflected laser light is captured for dimension measurements.

It is important that the conveyor moving surface does not interfere with measurements such that measurements are taken only when one of wallboard panels (10) is withing the measurement area. Thus, the non-contact encoder can be mounted over the gap (129) such that the measuring area fits within the gap (129) and measurements are not taken unless and until a moving wallboard panel enters the measuring area. In the alternative, the non-contact encoder and its emitted laser wavelength can be programmed to distinguish between a color of the wallboard surface and a color of the conveyor surface such that only the wallboard surface color triggers sufficient laser light reflection which is captured and processed by the non-contact encoder (108).

When in use, the non-contact encoder (108) may be arranged in operable communication with a processor (112) and/or a controller (110), the two devices may be integrated into one device in some embodiments. The processor (112) may be in operable arrangement with a non-transitory, computer-readable medium bearing a program for analyzing data, e.g., frequency, velocity, etc. transmitted to the processor (112) from the non-contact encoder (108).

The processor (112) may comprise any suitable computing device, e.g., a microprocessor, a portable computing device. It may also include one or more input/out devices, e.g., a keyboard and/or a display. The processor may have one or more memory devices, e.g., RAM (Random Access Memory). Preferably, the processor (112) is configured to execute a program stored in a non-transitory computer readable medium, e.g., a hard drive, the program configured to analyze data received from the non-contact encoder (108) and compute dimensions such as length, width and/or thickness of a moving wallboard panel (10). The program may include a graphic user interface that can be displayed on a display device, including inputs by a user and outputs generated by the program, including an edge profile image. The program may further include comparing the computed dimension to a specification requirement for the dimension and generating an alert signal, e.g., a sound alert and/or a text message to a user, when the computed dimension does not fit withing a tolerance range for the specification requirement. In this disclosure, a wallboard panel is referred to as a non-compliant wallboard panel (11) when one or more of its dimensions do not fit withing the tolerance range.

Finished wallboard panel specifications may be available from product procedure bulletins. A rejection limit may be referred in this disclosure as a tolerance range. In connection with preferred embodiments of a length value for the wallboard panel, the wallboard panel length is within a tolerance range if it is shorter than a specification length value by no more than 5 mm, and preferably by no more than 3 mm. Preferably, the length tolerance value may be defined as follows: the nominal length value plus 0 or minus 3 mm.

In connection with preferred embodiments of a width value for the wallboard panel, the wallboard panel length is within a tolerance range if it is smaller than a specification width value by no more than 3 mm, and preferably by no more than 2.4 mm. Preferably, the width tolerance value may be defined as follows: the nominal width value plus 0 or minus 2.4 mm. In preferred embodiments for wallboards with square edges, an edge profile may meet a specification when deviation is no more than 1.5 mm maximum off square in 1200 mm of width.

In some embodiments of the system (100), the non-contact encoder (108) may be configured to operate in response to receiving a command signal from the controller (110) which can be configured to set time intervals at which measurements are to be performed, among other tasks. The controller (110) may include one or more user interface and/or input devices, such as for example, as a keyboard and/or a display screen, which may be adapted to receive input signals from a user. In some embodiments, the controller (110) may be in the form of a desktop computer, laptop computer, computer tablet or a smart phone. The processor (112) may be configured to send input signals to the controller (110) as well as to receive input signals from the controller (110) which may be further configured for controlling operation of the conveyor (106) for example by increasing or decreasing a speed at which the conveyor (106) moves wallboard panels.

The controller (110) may also be in operable connection with the non-compliant product ramp (116) located downstream from the non-contact encoder (108). In some embodiments of the system (100), the non-compliant product ramp (116) may be positioned after the non-contact encoder (108). The non-compliant product ramp (116) is configured for receiving the non-compliant wallboard panel (11) from the post-kiln conveyor (106).

In some embodiments, the non-compliant product ramp (116) may be separated from the post-kiln conveyor (106) by a gate which may have an open position and a closed position. The non-compliant product ramp (116) is configured for receiving the wallboard panel (11) from the post-kiln conveyor (106) when the gate is in the open position. When the gate is in the closed position, the gate blocks the non-compliant product ramp (116) from receiving the wallboard panel (11). In preferred embodiments, the controller (110) may be in operable communication with the gate, sending instructions to the gate to move into the open position when the processer (112) sends instructions to the controller (110) that dimensions of a wallboard panel are not withing a tolerance range and the wallboard panel (11) is a non-compliant product to be moved through the non-compliant product ramp (116) for recycling. In some embodiments, the conveyor (106) may be equipped with a rotating table or bridge instead which diverts non-compliant wallboard panels (11) from the conveyor to the non-compliant product ramp (116) when instructed by the controller (110).

Wallboard panels (10s) that are processed by the non-contact encoder (108) as compliant with specification requirements reach the second location (B) on the conveyor (106) and then are transferred to the packaging station (114), wherein wallboard panel edges may be taped and wallboard panels may be stock-piled and/or packaged for shipment to a user.

The system (100) may include a production line (102) for forming wallboard panels, such as for example as wallboard panels (10). The production line (102) may include a mixer for mixing a gypsum slurry, the mixer being disposed over a moving conveyor onto which a facer cover sheet is deposited from a roll. The gypsum slurry is then deposited onto a moving facer cover sheet and covered with a backer cover sheet deposited over the gypsum slurry from a second roll. The formation continues moving on a conveyor to a forming station pressing the formation into a continuous ribbon precursor of a wallboard panel, which is then moved to a knife station at which the ribbon is cut into wallboards which are then transferred from the production line to a kiln (104), wherein the wallboard panels are dried at an elevated temperature.

The system (100) may further include various additional components and stations that are commonly used in manufacturing of wallboards or for their packaging. For example, the system may include one or more laser scanners positioned at the production line (100) for monitoring formation of a gypsum ribbon, for example as described in U.S. Pat. No. 9,745,222.

The system (100) may include at least one kiln (104) configured for receiving the wallboards, e.g., wallboards (10), from the production line (102). The kiln (104) dries wallboards at an elevated temperature. The kiln (104) may have one or more heaters and one or more shelves for drying the wallboard panels (10).

Suitable wallboard manufacturing methods and production line embodiments can be found in U.S. Pat. Nos. 6,494,609, 6,874,930, and 6,986,812, the entire disclosures of which are herein incorporated by reference.

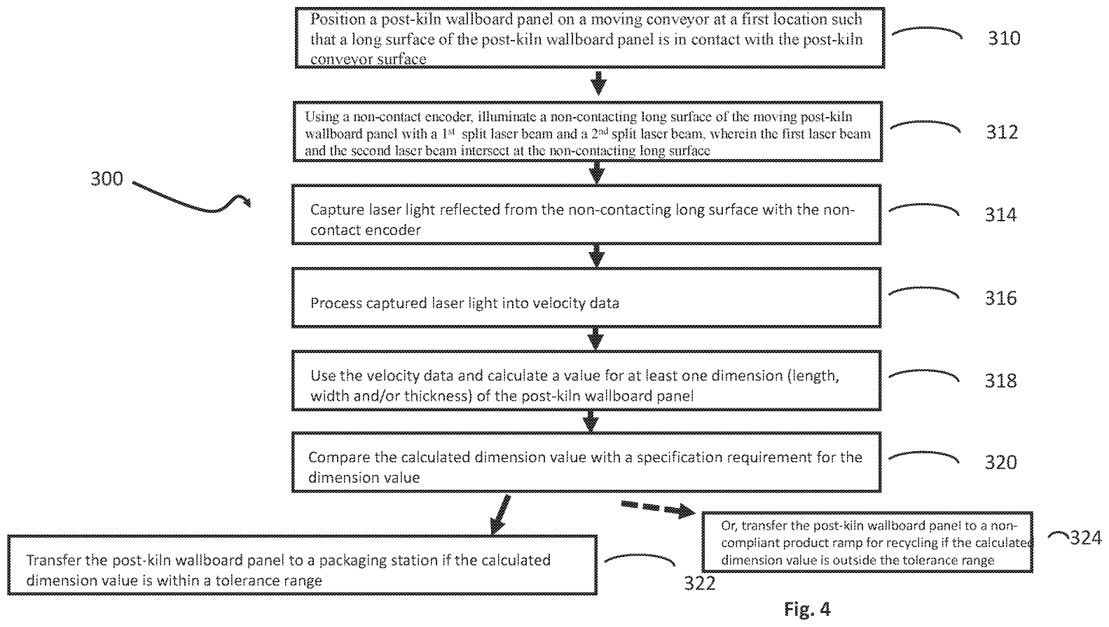

In another aspect, this disclosure relates to methods for post-kiln processing of wallboard panels. These methods may be performed by using the system (100). Referring to FIG. 4, a method for processing a post-kiln wallboard panel, generally (300), may comprise steps (310) through (324).

In step (310), the post-kiln wallboard panel (10) is positioned on the moving conveyor surface (106) of the system (100) at the first location such that a long surface of the post-kiln wallboard panel (10) is in contact with the post-kiln conveyor surface (106).

In step (312), the non-contacting long surface (10F) of the moving wallboard panel (10) is illuminated with at least the first laser beam (124) generated by the non-contact encoder (108) and a second laser beam (126) generated by the non-contact encoder (108), wherein the first laser beam (124) and the second laser beam (126) intersect at the non-contacting long surface (10F).

In step (314), the sensor (122) of the non-contact recorder (108) captures laser light reflected from the non-contacting long surface (10F).

In step (316), the processor (128) processes laser light captured in step (314) into velocity data.

In step (318), a value for at least one wallboard panel dimensions (length, width and/or thickness) is calculated, preferably by using the processor (128) and/or the processor (112).

In step (320), the calculated dimension value of step (318) is analyzed against a tolerance range for the calculated dimension value and the wallboard panel is encoded as compliant product (10) if the calculated dimension value is within the tolerance range or as non-compliant product (11) if the calculated dimension value is not within the tolerance range.

In step (322), the wallboard panel (10) is transferred to the packaging station (114) if the wallboard panel is a compliant product, or in the alternative, the wallboard panel is transferred to the non-compliant product ramp (116) in step (324) for recycling if the wallboard panel is a non-compliant product. At the packaging station (114), long edges of the wallboard panel may be taped and/or several wallboard panels, e.g., at least two wallboard panels, may be assembled into a stack. Preferred embodiments of the method (300) may further comprise plotting a long edge profile or any other profile of the wallboard panel and displaying the profile on the display (130).

In yet another aspect, this disclosure relates to a manufacturing method for manufacturing wallboard panels by using the system (100) and/or by steps (310) through (324).

Suitable methods for manufacturing wallboards on a production line are well known in the art, including as described in U.S. Pat. Nos. 6,494,609, 6,874,930, 6,986,812, 9,745,222 and 10,620,052, the entire disclosure if which is herein incorporated by reference.

The manufacturing methods according to this disclosure may comprise: mixing a gypsum slurry from calcined gypsum, water and one or more additives; depositing the gypsum slurry on a facer paper cover sheet continuously moving on a production line; covering the gypsum slurry with a backer paper cover sheet; forming a ribbon precursor of wallboard panel; cutting the ribbon into wallboard panels; transferring the wallboard panels to a kiln; drying the wallboard panels in the kiln; transferring the wallboard panels from the kiln; and performing the method (300), preferably including steps (310) through (324) and further optionally any additional steps as were disclosed in connection with the method (300).

Suitable additives to a gypsum slurry may include, but are not limited to, one or more of the following: phosphate compounds, dispersants, set accelerating agents, set retarding agents, foaming agents, defoaming agents, water-repelling agents, inert fillers, a binder and/or fibers, among other additives. In some embodiments, a gypsum slurry may be formulated as described in one or more of the following U.S. Pat. Nos. 2,078,199, 3,573,947, 5,643,510, 5,683,635, 5,798,425, 6,409,825, 6,777,517, 7,767,019, 7,803,226. This gypsum slurry can then be used for forming a wallboard panel suitable for processing with the systems and methods according to this disclosure.

The systems and methods according to this disclosure may be used for manufacturing wallboard panels and tiles having accurate dimension compliance with specification requirements. The wallboard panels and tiles can be used in any of building construction applications in which commercially available wallboard panels and tiles, including, but not limited to, for building interior walls and ceilings can be used.

Because the width and length of the wallboard panels encoded as compliant product are accurately measured, the wallboard panels according to this disclosure can be used in installation methods wherein one of the technical advantages is a reduced time needed for installation because the length of the wallboard panels, when used in full length applications, matches accurately.

These interior wall installation methods may include at least the following steps: obtaining a wallboard panel processed by the method (300) and/or processed by using the system (100) and affixing the wallboard panel to one or more studs such that a back long surface of the wallboard panel is facing toward the one or more studs.

What is claimed is:

1. A system for processing a post-kiln wallboard panel having a length, a width and a thickness, the length being longer than the width, the post-kiln wallboard panel having two long surfaces, a front long surface and a back long surface, the post-kiln wallboard panel having a first long edge and a second long edge, the system comprising:
a post-kiln conveyor having a surface configured for receiving a post-kiln wallboard panel at a first location,
the conveyor surface further configured for moving horizontally the post-kiln wallboard panel on the conveyor surface from the first location to a second location,
the conveyor surface being sized for moving the post-kiln wallboard panel with one of the two long surfaces contacting the conveyor surface and the other long surface not contacting the conveyor surface; and
a non-contact encoder configured for producing a laser beam, splitting the laser beam into at least a first laser beam and a second laser beam, and transmitting the first laser beam and the second laser beam to the conveyor surface,
the non-contact encoder being mounted vertically above the post-kiln conveyor at a distance from the conveyor surface, the distance configured such that the first laser beam and the second laser beam intersect and overlap fully or substantially fully at the non-contacting long surface of the post-kiln wallboard panel when the post-kiln wallboard panel is passing under the non-contact encoder.

2. The system of claim 1, wherein the non-contact encoder is configured for splitting the laser beam into 2, 3, or 4 laser beams.

3. The system of claim 1, wherein the conveyor surface has a first portion, a second portion separated from the first portion by a gap, wherein the gap is perpendicular to a direction of the movement from the first location to the second location, and wherein the gap has a width which is smaller than the length or the width of the post-kiln wallboard panel, and wherein the gap is configured for the post-kiln wallboard panel to traverse the gap from the first portion to the second portion of the conveyor surface, and wherein the non-contact encoder transmits the first laser beam and the second laser beam to the gap area.

4. The system of claim 3, wherein the first portion of the conveyor surface comprises one or more rollers or a belt and the second portion of the conveyor surface comprises one or more rollers or a belt.

5. The system of claim 1, wherein the non-contact encoder comprises:
a) a laser source configured for emitting a laser beam;
b) a laser beam splitter configured for spilling the emitted laser beam into at least a first laser beam and a second laser beam and directing the second beam to intersect with the first laser beam at the distance;
c) a sensor detecting laser light reflected from the non-contacting long surface, and
d) a processor.

6. The system of claim 1, wherein the distance is in the range from about 8 inches to about 12 inches from the conveyor surface, wherein the non-contact encoder is mounted perpendicular or substantially perpendicular to the direction of wallboard panel movement.

7. The system of claim 1, wherein the surface of the post-kiln conveyor is sized for moving the post-kiln wallboard panel with the wallboard long edges being moved in the machine direction.

8. The system of claim 1, wherein the system further includes a packaging station, the packaging station located at the second location.

9. The system of claim 1, wherein the system further includes a non-compliant product ramp positioned after the non-contact encoder, the non-compliant product ramp being configured for receiving the wallboard panel from the post-kiln conveyor.

10. The system of claim 9, wherein the non-compliant product ramp is separated from the post-kiln conveyor by a gate, the gate having an open position and a closed position, the non-compliant product ramp configured for receiving the wallboard panel from the post-kiln conveyor when the gate is in the open position and the gate blocking the non-compliant product ramp from receiving the wallboard panel when the gate is in the closed position.

11. The system of claim 1, wherein the system further comprises one or more of the following: a production line, a kiln and/or one or more controllers.

12. The system of claim 1, wherein the first laser beam and the second laser beam intersect at 60 degrees or less than 60 degrees.

13. The system of claim 1, wherein the post-kiln conveyor surface contains a bend and/or rotating table at which a movement direction of wallboard panel long edges is changed from the machine direction to the cross-machine direction or vice versa, and a second non-contact encoder is positioned after the bend, but before the second location.

14. A method for processing a post-kiln wallboard panel, the method comprising:
1) Positioning the post-kiln wallboard panel on the moving conveyor surface of the system of claim 1 at the first location such that a long surface of the post-kiln wallboard panel is in contact with the post-kiln conveyor surface,
2) Illuminating a non-contacting long surface of the moving post-kiln wallboard panel with the first laser beam generated by the non-contact encoder and the second laser beam generated by the non-contact encoder, wherein the first laser beam and the second laser beam intersect at the non-contacting long surface,
3) Capturing laser light reflected from the non-contacting long surface,
4) Processing captured laser light of step 3) into velocity data,
5) Calculating a value for at least one dimension of the post-kiln wallboard panel by using the velocity data obtained in step 4),
6) Analyzing the dimension value calculated in step 5) against a tolerance range and encoding the post-kiln wallboard panel as compliant product or non-compliant product, and
7) Transferring the post-kiln wallboard panel from the post-kiln conveyor to a packaging station if the post-kiln wallboard panel is encoded as compliant product or transferring the post-kiln wallboard panel to a non-compliant product ramp if the post-kiln wallboard is encoded as non-compliant product.

15. The method of claim 14, wherein at least one of the following dimensions is calculated in step 5): a length, a width and/or a thickness of the post-kiln wallboard panel.

16. The method of claim 14, wherein the method further comprises plotting a long edge profile and displaying it on a display.

17. The method of claim 14, wherein the method further comprises taping edges of the post-kiln wallboard panel at the packaging station.

18. The method of claim 14, wherein the method further comprises transferring the post-kiln wallboard panel from the non-compliant ramp to recycling.

19. The method of claim 14, wherein a length is calculated in step 5) and the tolerance range is no more than 5 mm negative deviation from a specification value for the length and/or wherein a width is calculated in step 5) and the tolerance range is no more than 3 mm negative deviation from a specification value for the width.

20. A method for manufacturing a wallboard panel, the method comprising:
mixing a gypsum slurry from calcined gypsum, water and one or more additives;
depositing the gypsum slurry on a facer paper cover sheet continuously moving on a production line;
covering the gypsum slurry with a backer paper cover sheet;
forming a ribbon precursor of wallboard panel;
cutting the ribbon into wallboard panels;
transferring the wallboard panels to a kiln;
drying the wallboard panels in the kiln;
transferring the wallboard panels from the kiln; and
performing steps 1) through 7) of the method according to claim 14.
